(19) United States
(12) Patent Application Publication
(10) Pub. No.: US 2019/0119445 A1
(43) Pub. Date: Apr. 25, 2019

(54) NOVEL COMPOSITIONS FOR PRODUCING CAST POLYAMIDES

(71) Applicants: Andreas KUGLER, Mannehim (DE); Armin ECKERT, Oberhausen-Rheinhausen (DE); Wilhelm LAUFER, Ellerstadt (DE); Michael WITT, Eckersdorf (DE); Detlev JOACHIMI, Krefeld (DE); Gunter MARGRAF, Dormagen (DE); Thomas FRUH, Wuppertal (DE)

(72) Inventors: Andreas KUGLER, Mannehim (DE); Armin ECKERT, Oberhausen-Rheinhausen (DE); Wilhelm LAUFER, Ellerstadt (DE); Michael WITT, Eckersdorf (DE); Detlev JOACHIMI, Krefeld (DE); Gunter MARGRAF, Dormagen (DE); Thomas FRUH, Wuppertal (DE)

(73) Assignee: LANXESS Deutschland GmbH, Cologne (DE)

(21) Appl. No.: 16/221,909

(22) Filed: Dec. 17, 2018

Related U.S. Application Data
(63) Continuation of application No. 14/342,155, filed on Oct. 31, 2014.

(30) Foreign Application Priority Data
Sep. 8, 2011 (EP) 11180557.8
Jun. 4, 2012 (EP) 12170746.7

(51) Int. Cl. C08G 69/18; C08G 69/14; C08G 69/20; C08L 77/02

(52) U.S. Cl. CPC C08G 69/18; C08G 69/14; C08K 5/29; C08L 77/02; C08G 69/20

(57) ABSTRACT

The present invention relates to novel compositions for production of cast polyamides.

This application is a continuation of U.S. patent application Ser. No. 14/342,155 filed Oct. 31, 2014, with the same title, which claims the right of priority under 35 U.S.C. § 119 (a)-(d) and 35 U.S.C. § 365 of International Application No. PCT/EP/2012/066985, filed Aug. 31, 2012, which is entitled to the right of priority of European Patent Application Nos. 12170746.7 and 11180557.8 filed Jun. 4, 2012 and September 8, 2011, respectively, the contents of which are hereby incorporated by reference in their entirety.

The present invention relates to novel compositions for production of cast polyamides.

In the production of cast polyamides, a lactam together with an at least one catalyst and at least one activator is transferred into a mold and then anionically polymerized in this mold. The starting compounds present in the mold polymerize, generally under the action of heat. This gives rise to a homogeneous material, which is superior to extruded polyamides in terms of crystallinity and mechanical properties.

Cast polyamides are suitable as thermoplastic polymers for the manufacture of complex components. In contrast to many other thermoplastics, they do not have to be melted but form through an anionic polymerization of a lactam in a mold at 120 to 150° C. within a few minutes. It is possible to employ all known casting processes, such as stationary casting, injection casting, rotary casting and centrifugal casting. The end products obtained in each case are moldings of a high molecular weight, crystalline polyamide which features a low weight, high mechanical durability, very good sliding properties and excellent chemical resistance, and which has only low internal stresses.

Cast polyamides can be sawed, drilled, machined, ground, welded and printed or painted; as well as complex hollow molds, examples of other articles produced from this polymer are rollers for passenger elevators and semifinished products, for example tubes, bars and sheets for mechanical engineering and the automobile industry. The production of fiber composite plastics by means of anionic in situ lactam polymerization is also known per se; see, for example: P. Wagner, Verarbeitung von Caprolactam zu Polyamid-Formteilen nach dem RIM-Verfahren [Processing of caprolactam to polyamide moldings by the RIM process], Kunststoffe 73 (10), pages 588-590 (1983).

The production of polyamide castings proceeding from low-viscosity lactam melts and a catalyst, and also an activator, by what is called activated polymerization, is known per se. For this purpose, typically two mixtures of catalyst and lactam and of activator and lactam are produced in the form of a liquid melt freshly before the polymerization and separately from one another, mixed directly with one another and then polymerized in a casting mold. The separate provision of monomer with activator and monomer with catalyst is intended to ensure that there is no early unwanted reaction.

This also entails separate storage of activator, catalyst and lactam, and thus causes a high apparatus requirement. Since the catalysts/activators are required only in small amounts, dosage is difficult. Inexact dosage leads to great variations in product quality and hence to defective batches. Moreover, both the activator and the catalyst are affected by repeated contacting with air and moisture. From the point of view of occupational hygiene, it is therefore desirable to provide activator and/or catalyst in a different and safer way.

It was thus an object of the present invention to provide storable compositions in which catalyst or activator with at least one lactam, or catalyst, activator and lactam, are present in storable form and which are suitable for production of cast polymers. “Storable” in the context of the invention means that these compositions are still usable for production of cast polymers after storage for several weeks, preferably storage for more than 20 days. Ideally, the residual monomer content in the cast polyamide is less than 1% by weight.

It has now been found that, surprisingly, solidified lactam melts with particular activators and solidified lactam melts with particular catalysts and/or lactam melts with particular activators and catalysts fulfill this criterion and requires only a small number of apparatuses/tanks for the production of the polyamide castings and the storage of the raw materials required therefor.

The present invention therefore provides compositions comprising
a) solidified lactam melts having 0.1-5% by weight of at least one polymeric carbodiimide, preferably of at least one polymeric aromatic carbodiimide, and/or of at least one uretdione as activator, and
b) solidified lactam melts having 0.2-5% by weight of catalyst selected from the group of: lactam magnesium halide, alkali metal aluminodilactamate, alkali metal and/or alkaline earth metal lactamate,
   and/or
c) solidified lactam melts having 0.2-5% by weight of catalyst selected from the group of: lactam magnesium halide, alkali metal aluminodilactamate, alkali metal and/or alkaline earth metal lactamate, and 0.1-5% by weight of at least one polymeric carbodiimide, preferably of at least one polymeric aromatic carbodiimide, and/or of at least one uretdione, optionally in combination with further solidified lactam melt b).

In a preferred embodiment, the present invention relates to compositions comprising:
a) solidified lactam melts having 0.1-5% by weight, preferably 0.2-2% by weight, more preferably 0.5-1.5% by weight, of at least one uretdione as activator, and
b) solidified lactam melts having 0.2-5% by weight of catalyst selected from the group of: lactam magnesium halide, alkali metal aluminodilactamate, alkali metal and/or alkaline earth metal lactamate,
   and/or
c) solidified lactam melts having 0.2-5% by weight of catalyst selected from the group of: lactam magnesium halide, alkali metal aluminodilactamate, alkali metal and/or alkaline earth metal lactamate, and 0.1-5% by weight of at least one uretdione.

The solidified lactam melts in the context of the invention are preferably amorphous or crystalline at temperatures of <70° C. The solidified lactam melts may be obtained as or be converted to powders, pellets, granules and/or flakes.

All standard finishing processes are possible, preferably pulverizing, pelletizing, flaking or granulating processes. For this purpose, it is possible to use commercially available apparatus, preferably mixer-granulators and mixers, obtainable, for example, from Lödige Process Technology, pelletizing belts or flaking rollers, obtainable, for example, from Sandvik Holding GmbH of from GMF Gouda.

The lactam used in the context of the invention is preferably at least one compound of the general formula (I)

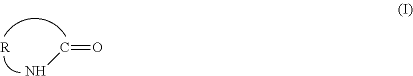

where R is an alkylene group having 3 to 13 carbon atoms. It is preferably caprolactam and/or laurolactam. These are commercially available, for example, from Lanxess Deutschland GmbH. Very particular preference is given to using caprolactam.

Uretdiones in the context of the invention are reaction products of at least two isocyanates with formation of dioxodiazetidine bonds:

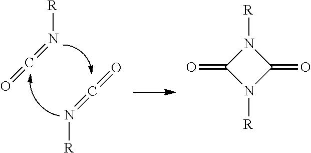

The preparation is known per se to those skilled in the art and can be undertaken for example, by the processes described in EP 1 422 223 Al.

The uretdione may be a dimer, trimer, oligomer or polymer. Suitable examples of uretdiones are known per se to those skilled in the art. Preferred uretdiones are 2,4-diisocyanatotoluene (TDI) uretdione (2,4-dioxo-1,3-diazetidine 1,3-bis(3-methyl-m-phenylene)diisocyanate), diphenylmethane 4,4′-diisocyanate (MDI) uretdione (bis(4-((4-isocyanatophenyl)methyl)phenyl)-1,3-diazetidine-2,4-dione) or hexamethylene 1,6-diisocyanate (HDI) uretdione (1,3-bis(6-isocyanatohexyl)-1,3-diazeditine-2,4-dione).

The aforementioned compounds are commercially available and are obtainable, for example, under the Addolink® and Addonyl® TT product names from Rhein Chemie Rheinau GmbH, or under the Desmodur® product names from Bayer MaterialScience AG.

Further examples of uretdiones which are obtained proceeding from an aliphatic or aromatic isocyanate have preferably 6 to 20 carbon atoms, more preferably 6 to 15 carbon atoms. Corresponding aromatic monomeric isocyanates may be selected, for example, from the group consisting of 2,6-diisocyanatotoluene, 2,4-methylenebis(phenyl diisocyanate), naphthylene 1,5-diisocyanate, N,N′ -bis(4-methyl-3-isocyanatophenyl)urea and tetramethylxylylene diisocyanate.

Corresponding aliphatic monomeric isocyanates are preferably selected from the group consisting of isophorone diisocyanate, cyclohexyl 1,4-diisocyanate, 1,1-methylenebis(4-isocyanatocyclohexane), 1,2-bis(4-isocyanatononyl)-3-heptyl-4-pentylcyclohexane.

Polymeric carbodiimides in the context of the invention are preferably compounds of the formula (II)

R¹—(—N═C═N—R²—)ₘ—R³ (II)

in which

m is an integer from 2 to 500, preferably from 2 to 50, most preferably from 2 to 200,

R¹═R²—NCO, R²—NHCONHR⁴, R²—NHCONR⁴R⁵ or R²—NHCOOR⁶,

R²═C₁-C₁₈-alkylene, C₅-C₁₈-cycloalkylene, arylene and/or C₇-C₁₈-aralkylene, preferably arylene and/or C₇-C₁₈-aralkylene, and

R³═—NCO, —NHCONHR⁴, —NHCONR⁴R⁵ or —NHCOOR⁶,

where R⁴ and R⁵ in R¹ are the same or different and are each independently a C₁-C₆-alkyl, C₆-C₁₀-cycloalkyl or C₇-C₁₈-aralkyl radical and R⁶ has one of the definitions of R¹ or is a polyester or polyamide radical or —(CH₂)ₕ—O—┌(CH₂)ₖ-O┐_{g}—R⁴,

where 1=1-3, k=1-3, g=0-12 and

R⁴═H or C₁-C₄-alkyl.

Likewise usable are also mixtures of polymeric carbodiimides of the formula (II).

The compounds of formula (II) are commercially available, for example from Rhein Chemie Rheinau GmbH, or can be prepared by processes familiar to the person skilled in the art, as described, for example, in DE-A-11 30 594 or U.S. Pat. No. 2,840,589, or by the condensation of diisocyanates, preferably 2,4,6-triisopropylphenyl 1,3-diisocyanate, 2,4,6-triethylphenyl 1,3-diisocyanate, 2,4,6-trimethylphenyl 1,3-diisocyanate, 2,4′-diisocyanatodiphenylmethane, 3,3′,5,5′-tetraisopropyl-4,4′-diisocyanatodiphenylmethane, 3,3′,5,5′-tetraethyl-4,4′-diisocyanatodiphenylmethane, tetramethylxylene diisocyanate, naphthalene 1,5-diisocyanate, diphenylmethane 4,4′-diisocyanate, diphenyldimethylmethane 4,4′-diisocyanate, phenylene 1,3-diisocyanate, phenylene 1,4-diisocyanate, tolylene 2,4-diisocyanate, tolylene 2,6-diisocyanate, a mixture of tolylene 2,4-diisocyanate and tolylene 2,6-diisocyanate, hexamethylene diisocyanate, cyclohexane 1,4-diisocyanate, xylylene diisocyanate, isophorone diisocyanate, dicyclohexylmethane 4,4′-diisocyanate, methylcyclohexane diisocyanate, tetramethylxylylene diisocyanate and 1,3,5-triisopropylbenzene 2,4-diisocyanate or mixtures thereof, with elimination of carbon dioxide at elevated temperatures, preferably at 40° C. to 200° C., in the presence of catalysts. Useful catalysts have been found to be preferably strong bases or phosphorus compounds. Preference is given to using phospholene oxides, phospholidines or phospholine oxides, and the corresponding sulfides. In addition, the catalysts used are tertiary amines, basic metal compounds, metal carboxylates and nonbasic organometallic compounds.

The catalysts used for the anionic polymerization of lactams in the context of the invention may be lactam magnesium halides, preferably bromides, alkali metal aluminodilactamates, preferably sodium, alkali metal and/or alkaline earth metal lactamates, preferably sodium, potassium and/or magnesium, individually or in a mixture.

The aforementioned catalysts are commercially available and are obtainable, for example, from Rhein Chemie Rheinau GmbH or from KatChem spol.s.r.o.

In a preferred embodiment of the invention, mixtures of a) and b) are polymerized at temperatures between 80 and 200° C., preferably 80 and 190° C., more preferably 80 to 160° C., especially preferably 100 to 160° C.

In a likewise preferred embodiment of the invention, mixtures of a), b) and c) are polymerized at temperatures between 80 and 200° C., preferably 80 and 190° C., more preferably 80 to 160° C., especially preferably 100 to 160° C.

In a further preferred embodiment of the invention, c) is polymerized at temperatures between 80 and 200° C., preferably 80 and 190° C., more preferably 80 to 160° C., especially preferably 100 to 160° C.

In a further preferred embodiment of the invention, mixtures of a) and c) are polymerized at temperatures between 80 and 200° C., preferably 80 and 190° C., more preferably 80 to 160° C., especially preferably 100 to 160° C.

In a further preferred embodiment of the invention, mixtures of b) and c) are polymerized at temperatures between 80 and 200° C., preferably 80 and 190° C., more preferably 80 to 160° C., especially preferably 100 to 160° C.

The respective polymerization is effected by the processes familiar to those skilled in the art, as described, for example, in Kunststoffhandbuch [Plastics handbook], vol. 3/4, Technische Thermoplaste [Industrial thermoplastics], Hanser Fachbuch, pages 413-430. The mixture is preferably polymerized directly in the casting mold.

The respective polymerization is preferably effected with exclusion of air humidity, or else under reduced pressure or in inert atmosphere.

In a further preferred embodiment of the invention, the following are added to the solidified lactam melts a) and b) and/or the solidified lactam melts c): further lactam and/or further catalyst and/or activator and/or optionally further additives, such as impact modifiers, preferably polyetheramine copolymers, glass fibers, continuous glass fibers, carbon fibers, aramid fibers and/or processing aids, preferably high molecular weight polyols, thickeners, preferably Aerosils, UV stabilizers and thermostabilizers, conductivity improvers, preferably carbon blacks and graphites, ionic liquids, markers and/or dyes.

Depending on the later use, the solidified lactam melts a) and b) are usable in any ratios. Preference is given to ratios of a) to b) of 1:3 to 3:1, more preferably ratios of 1:1.

Preference is given to a ratio of activator to catalyst in the inventive composition of 1:2. This ratio can also be established by a) and b) alone, a) and b) in combination with c), by a) and c), and b) and c) with later dosage of activator and/or catalyst. In a further preferred embodiment of the invention, the composition comprises at least one further component selected from fillers and/or reinforcers, additional polymers other than the uretdiones and/or further additives which differ chemically from the catalyst and activator to be used.

Preference is given to adding these additional components to the solidified lactam melt a) together with the polymeric carbodiimide and/or the uretdione.

Preference is likewise given to the addition of these additional components to the solidified lactam melt b) together with the catalyst.

In a further embodiment of the invention, these additional components are added to the solidified lactam melt c) together with the polymeric carbodiimide and/or the uretdione and the catalyst.

Fillers and/or reinforcers in the context of the invention are organic or inorganic fillers and/or reinforcers. Preference is given to inorganic fillers, especially kaolin, chalk, wollastonite, talc, calcium carbonate, silicates, titanium dioxide, zinc oxide, graphite, graphenes, glass particles (e.g. glass beads), nanoscale fillers (such as carbon nanotubes carbonanotubes), carbon black, sheet silicates, nanoscale sheet silicates, nanoscale aluminum oxide (Al₂O₃), nanoscale titanium dioxide (TiO₂) and/or nanoscale silicon dioxide (SiO₂).

Particular preference is given to using one or more fibrous substances selected from known inorganic reinforcing fibers, especially boron fibers, glass fibers, wood fibers, carbon fibers, silica fibers, ceramic fibers and basalt fibers; organic reinforcing fibers, especially aramid fibers, polyester fibers, nylon fibers/polyamide fibers, polyethylene fibers; and natural fibers, especially wood fibers, flax fibers, hemp fibers and sisal fibers. Especially preferred is the use of glass fibers, especially chopped glass fibers, carbon fibers, aramid fibers, boron fibers, metal fibers and/or potassium titanate fibers.

More particularly, it is also possible to use mixtures of the fillers and/or reinforcers mentioned. The fillers and/or reinforcers selected are more preferably glass fibers and/or glass particles, especially glass beads.

The amount of fillers and/or reinforcers to be used is preferably 30 to 90% by weight, especially 30 to 80% by weight, more preferably 30 to 50% by weight, further preferably from 50 to 90% by weight.

The additional used polymers in the context of the invention are: polystyrene, styrene copolymer, especially styrene-acrylonitrile copolymers (SAN), acrylonitrile-butadiene-styrene copolymers (ABS) or styrene-butadiene copolymers (SB), polyphenylene oxide ethers, polyolefins, especially polyethylene (HDPE (high-density polyethylene), LDPE (low-density polyethylene), polypropylene or poly-1-butene, polytetrafluoroethylene, polyesters, especially polyethylene terephthalate (PET); polyamides, polyethers, especially polyethylene glycol (PEG), polypropylene glycol or polyether sulfones (PESU or PES); polymers of monomers containing vinyl groups, especially polyvinyl chloride, polyvinylidene chlorides, polystyrene, impact-modified polystyrene, polyvinylcarbazole, polyvinyl acetate, polyisobutylenes, polybutadiene and/or polysulfones. It is additionally possible to use copolymers as the polymer, these consisting of the monomer units of the abovementioned polymers.

In a further embodiment of the invention, the polymer to be used may contain groups suitable for formation of block copolymers and/or graft copolymers with the polymer formed from the monomers. Examples of such groups are epoxy, amine, carboxyl, anhydride, oxazoline, carbodiimide, urethane, isocyanate and lactam groups. Polymers having carbodiimide groups are used when no carbodiimide is used as an activator.

Polymer optionally present is preferably present in an amount of 0 to 40% by weight, more preferably of 0 to 20% by weight, especially preferably in an amount of 0 to 10% by weight.

In a preferred embodiment, the inventive composition comprises further additives. The additives are preferably used in an amount of 0 to 5% by weight, more preferably of 0 to 4% by weight, most preferably of 0 to 3.5% by weight. The additives added may preferably be stabilizers, especially copper salts, dyes, antistats, filler oil, stabilizers, surface improvers, siccatives, demolding aids, separating agents, antioxidants, light stabilizers, stabilizers, lubricants, polyols, flame retardants, blowing agents impact modifiers and/or nucleating aids.

Suitable impact modifiers are especially polydiene polymers, preferably polybutadiene, polyisoprene, containing anhydride and/or epoxy groups. The polydiene polymer especially has a glass transition temperature below 0° C., preferably below −10° C., more preferably below −20° C. The polydiene polymer may be based on the basis of a polydiene copolymer with polyacrylates, polyethylene acrylates and/or polysiloxanes, and be prepared by means of the standard processes, preferably by emulsion polymerization, suspension polymerization, solution polymerization, gas phase polymerization.

In a further preferred embodiment of the invention, the additive used is polyol in order to improve the impact resistance, obtainable, for example, from Rhein Chemie Rheinau GmbH under the Addonyl® 8073 name. Likewise usable are polyol triamines suitable in order to improve the low-temperature impact resistance. A suitable product is Addonyl® 8112. Preferably, the polyols are used in the concentration range of 1-20% by weight.

The optional addition of fillers and/or reinforcers and further additives may precede or coincide with the addition of catalyst and/or activator.

The inventive solidified melts a), b) and/or c) are preferably produced as follows:
Production of the solidified lactam melt a):

For this purpose, 0.1-5% by weight of at least one polymeric carbodiimide, preferably of at least one polymeric aromatic carbodiimides and/or of at least one uretdione, is added to a lactam melt at temperatures between 70 and 120° C., preferably at 80-100° C., homogenized and then cooled, preferably within a period of five minutes, more preferably within a period of one minute, to a temperature below 40° C., preferably pelletized on a cooled pelletizing belt or flaked on a flaking roller.
Production of the solidified lactam melt b):

For this purpose, 0.2-5% by weight of at least one of the aforementioned catalysts, preferably sodium caprolactamate or a sodium caprolactamate masterbatch, is added to a lactam melt at temperatures between 70 and 120° C., preferably 80-100° C., homogenized and then cooled, preferably within a period of five minutes, more preferably within a period of one minute, to a temperature below 40° C., preferably pelletized on a cooled pelletizing belt or flaked on a flaking roller.
Production of the solidified lactam melt c):

For this purpose 0.1-5% by weight of at least one polymeric carbodiimide, preferably of at least one polymeric aromatic carbodiimide and/or of at least one uretdione, is added to a lactam melt at temperatures between 70 and 120° C., preferably at 80-100° C., and 0.2-5% by weight of at least one of the aforementioned catalysts, preferably sodium caprolactamate or a sodium caprolactamate masterbatch, is separately added to a lactam melt at temperatures between 70 and 120° C., preferably at 80-100° C., homogenized separately in heated tanks, mixed together by means of a mixer at temperatures of 70 to 120° C., preferably 80-100° C., within less than 30 minutes, preferably within less than 10 minutes, more preferably within less than one minute, then cooled within a period of five minutes, more preferably within a period of one minute, to a temperature below 40° C., preferably pelletized on a cooled and pelletizing belt or flaked on a flaking roller, optionally under inert atmosphere, for example nitrogen.

The solidified lactam melts a), b) and c) are stored with protection from oxygen and humidity, preferably at temperatures between 4 and 30° C., more preferably at temperatures below 10° C.

The solidified lactam melts a), b) and c) feature storability for several weeks, such that it is possible to transport the mixtures to the site of use and store them before they are used.

Thus, it is possible to prepare the mixture exactly for the use and thus to avoid variations in the composition, as arise in the case of mixtures produced immediately before the polymerization.

In a preferred embodiment of the invention, the polymeric carbodiimides correspond to the compounds of the formula (II)

R¹—(—N═C═N—R²—)ₘ—R³ (II)

in which

m is an integer from 2 to 500,

R¹═R—NCO, R—NHCONHR⁴, R—NHCONR⁴R⁵ or R—NHCOOR⁶ and

R²=arylene and/or C₇-C₁₈-aralkylene and

R³═—NCO, —NHCONHR⁴, —NHCONR⁴R⁵ or —NHCOOR⁶,

where R⁴ and R⁵ in R¹ are the same or different and are each independently a C₁-C₆-alkyl, C₆-C₁₀-cycloalkyl or C₇-C₁₈-aralkyl radical and R⁶ has one of the definitions of R¹ and

R⁴═H or C₁-C₄-alkyl.

In the cases in which the inventive composition comprises a two-component mixture of a) and b) or a) and c), or b) and c), or else the mixture of a), b) and c), the necessary constituents of the two- or three-component mixture are stirred in standard mixing apparatus.

Mixing can be accomplished using standard mixing apparatus, horizontal or vertical mixers, preferably paddle mixers, belt mixers, ploughshare mixers, annular bed mixers or mixer-granulators, which are commercially available, for example from Lodige Process Technology.

Here too, it is preferable that the polymeric carbodiimides correspond to the compounds of the formula (II). Reference is made to the details given in this regard.

The subject matter of the present invention also encompasses composition of solidified lactam melts having 0.2-5% by weight of catalyst selected from the group of: lactam magnesium halide, alkali metal aluminodilactamate, alkali metal and/or alkaline earth metal lactamate, and 0.1-5% by weight of carbodiimide and/or uretdione, obtainable by mixing
a. at least one melt of caprolactam and 0.1-5% by weight of at least one polymeric carbodiimide, preferably of at least one polymeric aromatic carbodiimide, and/or of at least one uretdione, and
b. at least one melt of caprolactam and 0.2-5% by weight of at least one catalyst selected from the group of: lactam magnesium halide, alkali metal alumino dilactamate, alkali metal and/or alkaline earth metal lactamate

at temperatures of 70-120° C. over a period of 1-60 seconds, and subsequent finishing, preferably pelletization, pulverization, flaking or granulation, with cooling. This finishing can also be effected under inert gas.

Here too, it is preferable that the polymeric carbodiimides correspond to the compounds of the formula (II). Reference is made to the details given in this regard.

The subject matter of the present invention also includes a process for producing cast polyamides by polymerizing one or more constituents of the inventive composition in a casting mold at temperatures between 80 and 200° C., preferably 80 and 190° C., more preferably 80 to 160° C., especially preferably 100 to 160° C., preferably under reduced pressure, preferably <1 bar, or inert atmosphere, more preferably under nitrogen.

The polymerization is preferably effected by the processes described in Kunststoffhandbuch, vol. 3/4, Technische Thermoplaste, Hanser Fachbuch, pages 413-430.

In a further version of the present invention, the polymerization can be effected by a suitable shaping process, preferably injection molding process, such as Reactive Injection Molding (RIM), stationary casting processes or rotational casting processes. More preferably, the polymerization can be effected by the injection molding process.

The aforementioned inventive compositions are used preferably for production of plastics products as a substitute for metal, preferably in the automobile industry, in the production of electronic engineering parts, for the production of sheets, bars, tubes, rope pulleys, rope rollers, cogs and bearings, and/or for vessel manufacture. Also possible is the production of fibrous plastics. Usable fabrics are in this context are preferably glass fiber fabric, basalt fabric, carbon fiber, hybrid fabric composed of glass fibers and carbon fibers and/or aramid fabric.

The scope of the invention covers all combinations of radical definitions, indices, parameters and elucidations above and given below, in general or within areas of preference, i.e. including between the respective areas and areas of preference in any combination.

The examples which follow serve to illustrate the invention without having any limiting effect.

Working Examples:

Reagents:

(A) Dry caprolactam (softening point >69° C.) from Lanxess Deutschland GmbH;

(B) Addonyl® Kat NL from Rhein Chemie Rheinau GmbH, approx. 18% sodium caprolactamate in caprolactam;

As activators:

(C) Addonyl® 8108: aliphatic polyisocyanate solution, commercially available from Rhein Chemie Rheinau GmbH;

(D) Desmodur® H: hexamethylene diisocyanate, commercially available from Bayer MaterialScience AG,

(E) Stabaxol® P: aromatic polymeric carbodiimide, commercially available from Rhein Chemie Rheinau GmbH;

(F) Stabaxol® I: aromatic monomeric carbodiimide, commercially available from Rhein Chemie Rheinau GmbH;

(G) Addolink® TT: dimeric TDI uretdione, commercially available from Rhein Chemie Rheinau GmbH;

(H) Addonyl OTT: dimeric TDI uretdione, commercially available from Rhein Chemie Rheinau GmbH.

Procedure and Testing:

Production of the Two-Component Mixture from a) and b) (2 K Powder Mixture)

Caprolactam was melted at 75° C. and dried under reduced pressure for 20 min. Thereafter, the respective activator (apparent from table 1) was added while stirring, and the mixture was homogenized and poured into a nitrogen-blanketed aluminum mold. After the melt had solidified, it was comminuted and transferred into a nitrogen-blanketed sample bottle and stored.

In an analogous manner, caprolactam was melted at 75° C. and dried under reduced pressure for 20 min. Thereafter, Addonyl® Kat NL was added while stirring, and the mixture was homogenized and poured into a nitrogen-blanketed aluminum mold. After the melt had solidified, it was pulverized and transferred into a nitrogen-blanketed sample bottle and stored.

After 30 days, the corresponding powders comprising activator and catalyst were mixed in a mass ratio of 1:1 and transferred into a sample bottle, which was then used directly for the polymerization experiments described below.

Production of the One-Component Mixture c) (1 K Mixtures)

Caprolactam was melted at 75° C. and dried under reduced pressure for 20 min. Thereafter, the respective activator (apparent from table 1) was added while stirring, and the mixture was homogenized. In analogous manner, caprolactam was melted at 75° C. and dried under reduced pressure for 20 min. Thereafter, Addonyl® Kat NL was added while stirring and homogenized. The catalyst and activator melts thus obtaining were then combined and homogenized at 75° C. for a few minutes. The contents were then poured into a nitrogen-blanketed aluminum mold. After the melt had solidified, it was pulverized and transferred into a nitrogen-blanketed sample bottle and stored. After 30 days, the powder comprising activator and catalyst was transferred into a sample bottle and used for the polymerization experiments described below.

Polymerization Experiments

The sample bottles were placed into a drying cabinet at 160° C. After about 30 min, the sample was removed. The results are compiled in table 2.

TABLE 1
Formulations

| Experi- | | | | | | | | |
|---|---|---|---|---|---|---|---|---|
| ment | | (A) | (B) | (C) | (D) | (E) | (F) | (G) |
| number | Type of mixture | [g] | [g] | [g] | [g] | [g] | [g] | [g] |
| 1 | 2 K powder mixture | 388.8 | 8.0 | 3.2 | | | | |
| 2 | 2 K powder mixture | 388.8 | 8.0 | | 1.0 | | | |
| 3 | 2 K powder mixture | 388.8 | 8.0 | | | 3.2 | | |
| 4 | 2 K powder mixture | 388.8 | 8.0 | | | | 3.2 | |
| 5 | 2 K powder mixture | 388.8 | 8.0 | | | | | 3.2 |
| 6 | 2 K powder mixture | 388.8 | 16.0 | | | | | 3.2 |
| 7 | 2 K powder mixture | 377.6 | 16.0 | | | | | 6.4 |
| 8 | 1 K mixture | 388.8 | 8.0 | 3.2 | | | | |
| 9 | 1 K mixture | 388.8 | 8.0 | | | | | 3.2 |
| 10 | 1 K mixture | 388.8 | 8.0 | | | 3.2 | | |

TABLE 2
Results of the cast polymerization

| | | | Storage |
|---|---|---|---|
| Experiment | Polymerization | Appearance | stability |
| 1 (comparative) | No or incomplete | inhomogeneous | — |
| | reaction | | |
| 2 (comparative) | No or incomplete | inhomogeneous | — |
| | reaction | | |
| 3 (inventive) | Complete reaction | homogeneous | >30 days |
| 4 (comparative) | No reaction | — | — |
| 5 (inventive) | Complete reaction | homogeneous | >30 days |
| 6 (inventive) | Complete reaction | homogeneous | >30 days |
| 7 (inventive) | Complete reaction | homogeneous | >30 days |
| 8 (comparative) | No/incomplete | inhomogeneous | — |
| | reaction | | |
| 9 (inventive) | Complete reaction | homogeneous | >30 days |
| 10 (inventive) | Complete reaction | homogeneous | >30 days |

The residual monomer content of the inventive cast polyamides was less than 1% by weight.

Through the controlled and precise setting and selection of the activator and catalyst components required, it is therefore possible to provide storage-stable compositions which enabled use for production of polyamide castings with very low apparatus complexity.

Examples for Production of Cast PA6 Polymer Moldings and of Cast PA6 Polymer Composite Moldings from the Inventive Composition:

### EXAMPLE 11

Production of the Two-Component Mixture from a) and b) (2 K Powder Mixture)

193.6 g of caprolactam were melted at 75° C. Thereafter, 6.4 g of Addonyl OTT from Rhein Chemie Rheinau were added while stirring, and the mixture was homogenized and post-dried under reduced pressure for 5 min, and the melt was poured into a nitrogen-blanketed cold aluminum mold at 21° C. After the melt had solidified, it was comminuted and transferred into a nitrogen-blanketed sample bottle and stored at 6° C. in a refrigerator for one week.

In an analogous manner, 184 g of caprolactam were melted at 75° C. Thereafter, 16 g of Addonyl® Kat NL were added while stirring, and the mixture was homogenized and post-dried under reduced pressure for 5 min and poured into a nitrogen-blanketed cold aluminum mold at a temperature of 21° C. After the melt had solidified, it was pulverized and transferred into a nitrogen-blanketed sample bottle. The corresponding and at 6° C. in a refrigerator for one week stored.

These powders, comprising activator or catalyst, were removed from the refrigerator, mixed and introduced into a nitrogen-blanketed reservoir vessel/three-neck flask and then melted at a temperature of 90° C. and stored at this temperature for the experiments described hereinafter.

Every 10 minutes, a plastic pipette was used to take a 2 ml sample which was transferred into a test tube of internal diameter 5 mm heated to 170° C. with the aid of an oil bath.

Over a period of 30 minutes, it was possible to polymerize the melt to completion through the increase in temperature. The specimens were visually homogeneous.

### EXAMPLE 12

As in example 11, about 400 g of the activated caprolactam melt were made up in a three-neck flask under nitrogen.

A steel mold having a cavity of dimensions 20×30×0.2 cm consisted of two halves and was sealed with the aid of silicone seals. Before the experiment, two plies of predried glass fiber fabric (from PPG), basis weight about 600 m², 2/2 twill construction) were placed into the cavity and mechanically fixed. Twill is—alongside plain weave and satin weave—one of the three basic construction types for woven materials.

The steel mold had two bores through which the activated caprolactam melt from example 11 could flow into the cavity; through the second bore, after complete filling, the excess melt could emerge again.

The steel mold was heated to 170° C. and, with the aid of a vacuum pump which had been connected to one of the bores of the steel mold, the activated caprolactam melt from example 11 was sucked into the mold, where it soaked the fabric and then polymerized to completion.

After 30 minutes, the mold was opened and a fully polymerized composite plastic sheet was removed.

The composite plastic sheet was fully through-polymerized; the residual monomer content determined via a methanol extraction was below 1% by weight.

### EXAMPLE 13

Production of a One-Component Mixture (1 K Powder Mixture)

193.6 g of caprolactam were melted at 75° C. Thereafter, 6.4 g of Addonyl® TT from Rhein Chemie Rheinau were added while stirring, and the mixture was homogenized and post-dried under reduced pressure (<0.1 mbar) for another 5 min.

At the same time, in a second batch, 184 g of caprolactam were melted at 75° C. and, thereafter, 16 g of Addonyl® Kat NL were added while stirring, and the mixture was homogenized for 5 min and post-dried under reduced pressure (<0.1 mbar) for 5 min.

The two melts were combined by adding the activator-containing melt to the catalyst-containing melt and the combined melts were stirred for another 30 seconds.

Thereafter, the melt mixture was poured into a nitrogen-blanketed aluminum mold having a temperature of 21° C. After the melt had solidified, it was pulverized and transferred into a nitrogen-blanketed sample bottle and stored at 6° C. in a refrigerator for one week.

This powder, comprising both activator and catalyst, was removed from the refrigerator and introduced into a nitrogen-blanketed three-neck flask, where it was melted at a temperature of 90° C., and the melt mixture was stored at this temperature.

Every 10 minutes, a plastic pipette was used to take a 2 ml sample which was transferred into a test tube of internal diameter 5 mm which was heated to 170° C. with the aid of an oil bath.

Over a period of 30 minutes, it was possible to polymerize the melt to completion through the increase in temperature. The specimens were visually homogeneous.

### EXAMPLE 14

Production of the Two-Component Mixture of a) and b) (2 K Powder Mixture), by Combining Powders a) and b) after the Production and then Storing this Powder Mixture at Temperatures Below 10° C.

193.6 g of caprolactam were melted at 75° C. Thereafter, 6.4 g of Addonyl® TT from Rhein Chemie Rheinau were added while stirring, the mixture was homogenized and post-dried under reduced pressure (<0.1 mbar) for 5 min, and the melt was poured into a nitrogen-blanketed aluminum mold having a temperature of 21° C. After the melt had solidified, it was comminuted.

In an analogous manner, 184 g of caprolactam were melted at 75° C. Thereafter, 16 g of Addonyl® Kat NL were added while stirring, and the mixture was homogenized and post-dried under reduced pressure (<0.1 mbar) for 5 min and poured into a nitrogen-blanketed aluminum mold having a temperature of 21° C. After the melt had solidified, it was likewise comminuted into flakes.

The two powders were mixed in a mass ratio of 1:1 and transferred in the form of flakes into a nitrogen-blanketed sample bottle and stored at 6° C. in a refrigerator for one week.

These flakes were removed from the refrigerator and introduced into a nitrogen-blanketed three-neck flask, then melted at a temperature of 90° C., and the melt obtained was used for the production of a composite plastic as described in example 12.

In this case too, it was possible to produce a composite plastic sheet which had a residual monomer content of about 1% by weight.

What is claimed is:

1. A composition comprising:
at least two components selected from
a) a solidified lactam melt comprising 0.1-5% by weight of at least one polymeric aromatic carbodiimide, or of at least one uretdione, or both,
b) a solidified lactam melt comprising 0.2-5% by weight of at least one catalyst selected from the group of: lactam magnesium halide, alkali metal aluminodilactamate, alkali metal and alkaline earth metal lactamate, and
c) a solidified lactam melt comprising 0.2-5% by weight of at least one catalyst selected from the group of: lactam magnesium halide, alkali metal aluminodilactamate, alkali metal and alkaline earth metal lactamate, and 0.1-5% by weight of at least one polymeric aromatic carbodiimide, or of at least one uretdione, or both, or
the component c) only.

2. The composition as claimed in claim 1, wherein the composition comprises the solidified lactam melt c) in combination with solidified lactam melt b).

3. The composition as claimed in claim 1, wherein the lactam melt comprises compounds of the formula (I) 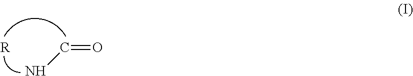
where R is an alkylene group having 3 to 13 carbon atoms.

4. The composition as claimed in claim 1, wherein the uretdione is prepared proceeding from monomeric compounds selected from the group of isophorone diisocyanate, cyclohexyl 1,4-diisocyanate, 1,1-methylenebis(4-isocyanatocyclohexane), 1,2-bis(4-isocyanatononyl)-3-heptyl-4-pentylcyclohexane, and hexamethylene 1,6-diisocyanate, and combinations thereof.

5. The composition as claimed in claim 1, wherein the uretdione comprises compounds which are obtained proceeding from an aromatic isocyanate selected from the group consisting of 2,4-diisocyanatotoluene, 2,6-diisocyanatotoluene, naphthylene 1,5-diisocyanate, methylenediphenyl 4,4′-diisocyanate, 1,3-bis(3-isocyanato-4-methylphenyl)-2,4-dioxodiazetidine, N,N′-bis(4-methyl-3-isocyanatophenyl)urea, and tetramethylxylylene diisocyanate, and combinations thereof.

6. The composition as claimed in claim 1, wherein the polymeric aromatic carbodiimide is at least one compound of the formula (II)
R¹—(—N═C═N—R²—)ₘ—R³ (II)
in which
m is an integer from 2 to 500,
R¹═R²—NCO, R²—NHCONHR⁴, R²—NHCONR⁴R⁵ or R²—NHCOOR⁶,
R²=arylene or C₇-C₁₈-aralkylene, and
R³═—NCO, —NHCONHR⁴, —NHCONR⁴R⁵ or —NHCOOR⁶,
where R⁴ and R⁵ in R¹ and R³ are the same or different, and are each independently a C₁-C₆-alkyl, C₆-C₁₀-cycloalkyl or C₇-C₁₈-aralkyl radical and R⁶ has one of the definitions of R¹ or is a polyester or polyamide radical or —(CH₂)ₕ—O—[(CH₂)ₖ—O]_{g}—R⁴,
where h=1-3, k=1-3, g=0-12 and
R⁴═H or C₁-C₄-alkyl.

7. The composition as claimed in claim 1, wherein the solidified lactam melts of a), b) and/or c) are in the form of at least one of: powder, pellets, granules and flakes.

8. A solidified lactam melt comprising:
0.2-5% by weight of at least one catalyst selected from the group consisting of: lactam magnesium halide, alkali metal aluminodilactamate, alkali metal and alkaline earth metal lactamate, and
0.1-5% by weight of carbodiimide or uretdione, or both, and obtained by mixing
at least one melt of caprolactam and 0.1-5% by weight of at least one polymeric aromatic carbodiimide, or of at least one uretdione, or both, and
at least one melt of caprolactam and 0.2-5% by weight of at least one catalyst selected from the group of: lactam magnesium halide, alkali metal aluminodilactamate, alkali metal and alkaline earth metal lactamate,
at temperatures of 70-120° C. over a period of 1-60 seconds, and subsequent finishing with cooling.

9. A process for producing cast polyamides by polymerizing the composition of claim 1 in a casting mold at a temperature of 100 to 160° C.

10. A cast polyamide obtained by polymerizing a composition as claimed in claim 1.
